(19) United States
(12) Patent Application Publication
(10) Pub. No.: US 2015/0265863 A1
(43) Pub. Date: Sep. 24, 2015

(54) Hose Gripping Apparatus

(71) Applicant: Thomas J. King, Warwick, NY (US)

(72) Inventor: Thomas J. King, Warwick, NY (US)

(21) Appl. No.: 14/661,625

(22) Filed: Mar. 18, 2015

Related U.S. Application Data
(63) Continuation of application No. 61/955,239, filed on Mar. 19, 2014.

(51) Int. Cl. A62C 33/04; B65G 7/12

(52) U.S. Cl. CPC A62C 33/04; B65G 7/12

(57) ABSTRACT

A hose gripping apparatus enhances a grip on a pressurized hose by magnifying applied force form an operator and creating a larger gripping surface. At least one pressure pad engages the hose and includes a generally concave shape and rigid composition. The concave surface area of the pressure pad conforms efficiently to the hose surface. When wrapped around the pressurized hose, the pressure pad provides the structure and shape necessary to magnify the applied grip from an operator. The pressure pad includes an inner rigid member and a slip resistant coating, such as rubber. A pair of straps attach to the pressure pads in a perpendicular orientation. The straps wrap around the pressurized hose, joining at a hook and loop fastening material from each end. The tightness is easily manipulated by the operator without tools. A handle provides a large gripping surface and orientation for operation of the hose.

### FIELD OF THE INVENTION

The present invention relates generally to a hose gripping apparatus. More so, a hose gripping apparatus securely and detachably wraps around a pressurized hose and provides a handle, so as to enhance the grip on a pressurized hose by magnifying a grip pressure on the hose during operation, facilitating manipulation of the hose, and adjusting for various hose sizes and pressures through the use of novel pressure padding and fastening configurations.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that a firehose is a high-pressure hose that carries water or other fire retardant to a fire to extinguish it. Outdoors, the firehose attaches either to a fire engine or a fire hydrant. Indoors, the firehose can permanently attach to a building's standpipe or plumbing system.

When operating at typical water pressures of 50-100 lbs, firehoses are extremely hard to handle. They are heavy, stiff, slippery and difficult to grip. Often, multiple firemen must join efforts in supporting and controlling the hoses, with the lead or nozzle man being particularly stressed. These problems are further compounded when the firehoses must be carried or pulled up stairwells or ladders, where fireman are frequently unable to keep both hands on the hose.

Generally, firehoses are designed with a smooth outer hose jacket in order to reduce friction while dragging the hose into position. This smooth jacket surface forms a poor gripping surface for the operator's hand, even if gloved. Thus, to better control the pressurized hose 200, the firefighter must pull it towards the chest area. This creates a heavy compression when the pressurized hose beats against the heart, ribs, breastbone, and general chest area; thus resulting in serious medical issues for the hose operator.

It is also known that in fire service, a hand operated firehose is sub classified as an attack line. A fully operating attack line will push back against the operator with great force. This force is known as back pressure. Back pressure, poor hand gripping surfaces, and the dead weight of a charged attack line, are not conducive to optimal firehose manipulations, such as advancement, aiming, and consistent control of the fire hose.

Furthermore, in everyday fire service, attack lines can be knocked, pulled, and pushed out of the hands of firefighters. A dislodged, flailing nozzle, is in itself, a serious hazard to human flesh. Furthermore, in shipboard firefighting, a loose attack line can literally wash a crewman overboard from a ship causing death or serious injury. But in any arena, an out of control attack line can be difficult and dangerous to recapture.

Typically, a ruptured firehose that is carrying pressure can create a hazard. Where an uncontrolled hand line is very dangerous, lost water due to a ruptured firehose can be even more devastating. A loss of water can quickly endanger all firefighters and civilians in the area. Control of the ruptured hose and subsequent ruptures are common difficulties in fire service. Either event can result in lost life and the loss of a structure.

Other proposed hinged, half shell hose gripping devices are more hose diameter specific, bulky, and cost prohibitive to manufacture. Unlike previous inventions, the present invention uses multiple gripping surfaces and can therefore be adjusted to fit any diameter attack line. It does not rely on hinges, springs or locking mechanisms. The wide binding straps can be easily grasped and the device applied and adjusted with a gloved hand. The binding straps, when inserted through the wide “D” rings or other buckle type, can be stretched and mechanically torqued down before being secured with hook and loop fabric. The stretchable bindings will allow for the inevitable pressure changes without reliance on springs or other mechanical parts. The wide looped handle is also easy to locate and grasp.

The present invention provides a large, highly visible, easily grasped, easily applied gripping apparatus, yet it can be can be neatly folded flat and stored unobtrusively in a coat pocket. The soft parts minimize the potential for injury. The device is cushioned and flexible to minimize injury potential and allows a firefighter to more readily recover the line should it be jarred loose. The soft looped handle minimizes the risk of injury to the hand or finger joints. The handle can be easily cut away with a pocket knife in the event of an entanglement of any kind. It does not readily conduct electricity, as will metal devices.

Other proposals have involved gripping devices that help control a pressurized hose. The problem with these gripping devices is that they do not magnify the force applied around the hose, and they are not compactable for facilitated stowage and transport. Also, the handle used to control the gripping device is not easily accessible. Even though the above cited gripping devices meets some of the needs of the market, a hose gripping apparatus that wraps around a pressurized hose and provides a handle, so as to enhance the grip on a pressurized hose by magnifying a grip pressure on the hose during operation, facilitating manipulation of the hose, and adjusting for various hose sizes and pressures is still desired.

### SUMMARY OF THE INVENTION

The present invention is directed to a hose gripping apparatus that securely and detachably wraps around a pressurized hose. The apparatus provides a handle and pressure pads that conform to the contour of the hose, so as to enhance the grip on the hose by magnifying a grip pressure on the hose during operation, facilitating manipulation of the hose, and adjusting for various hose sizes and pressures through the use of novel padding and fastening configurations. The apparatus is also compacts for facilitated stowage and transport.

In some embodiments, the apparatus may at least one pressure pad that transversely cross the hose. The pressure pad contours to the shape of the hose and is fabricated from resilient, yet rigid rubber materials that are efficacious for magnifying an applied grip pressure on the hose 200 during operation. It is these pressure pads, through their unique and layered composition, and rubber composition that magnify the force applied on the pressurized hose, and thereby enhance control thereof.

In one embodiment, the at least one pressure pad may include three generally rigid, elongated, and spaced-apart pads. The at least one pressure pad is defined by a generally concave shape. The generally concave shape of the at least one pressure pad is configured to magnify an applied force on a pressurized hose, such as a firefighting hose. The pressure pad comprises an inner rigid member configured to provide structural integrity to the pressure pad. The pressure pad further comprises a slip resistant coating configured to inhibit slippage between the apparatus and the hose.

In some embodiments, the apparatus may further include a pair of straps defined by a first end, a second end, an outer surface, and an inner surface. The pair of straps are configured to join with the at least one pressure pad in a substantially perpendicular orientation. The pair of straps are arranged to cross over the outer end of each pressure pad, fastening thereto. In one exemplary disposition, three pressure pads extend perpendicularly across the pair of straps, proximally to the first end of the straps. In one embodiment, at least one pad fastener 108 may pass through the junction where the straps meet the pressure pad, for securing the pressure pad to the pair of straps.

In some embodiments, the apparatus may further include a ring. The ring is disposed to join with the first end of the pair of straps. The ring is configured to enable the second end of the pair of straps to detachably attach to the first end of the pair of straps, such that the apparatus securely fastens around the pressurized hose. In another embodiment, an inner and outer fastening material on the first and second ends of the strap enable the apparatus to detachably join the hose.

In some embodiments, the apparatus may further include a handle for controlling and manipulating the hose. The handle is defined by a pair of handle ends that are disposed to join with opposite ends of the at least one pressure pad. The handle is configured to form a gripping surface for controlling the apparatus. In some embodiment, the apparatus compacts into a small unit for facilitated stowage and transport. From this compact position, the handle may still be used to carry the apparatus.

It is one objective of the present invention to provide an apparatus that enables a gloved hand to form a secure grip on a pressurized hose.

It is another objective to provide a gripping apparatus that securely and detachably fastens to a pressurized hose.

It is another objective to form a large grip surface area and an effective traction surface over the pressurized hose.

Yet another objective is to create an ergonomic grip strength for the applied pressure of the gloved hand of the operator.

Yet another objective is to magnify a hand grip pressure, minimize muscle fatigue, and enable efficient positioning and operation of a pressurized hose.

Yet another objective is to allow a hose operator to apply hand grip pressure rather than relying on tools, such as clamps and springs.

Yet another objective is to easily compact the apparatus for facilitated stowage and transport.

Yet another objective is to prevent heart and chest damage from pressurized hoses that beat across the chest when being handled by providing an apparatus to enable greater control of the hose.

Yet another objective is to manufacture an inexpensive apparatus that can be used to grip firehoses.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective of an exemplary hose gripping apparatus, in accordance with an embodiment of the present invention;

FIG. 2 illustrates a perspective view of an exemplary hose gripping apparatus prior to wrapping around an exemplary pressurized hose, in accordance with an embodiment of the present invention;

FIG. 3 illustrates a perspective view of an exemplary hose gripping apparatus wrapped around the pressurized hose, in accordance with an embodiment of the present invention;

FIG. 4 illustrates a close up view of an exemplary pressure pad with an outer slip resistant coating partially removed for illustration of an inner rigid member, in accordance with an embodiment of the present invention; and

FIG. 5 illustrates a perspective view of an exemplary gloved hand gripping an exemplary handle of the apparatus while wrapped around the hose, in accordance with an embodiment of the present invention.

Like reference numerals refer to like parts throughout the various views of the drawings.

### DETAILED DESCRIPTION OF THE INVENTION

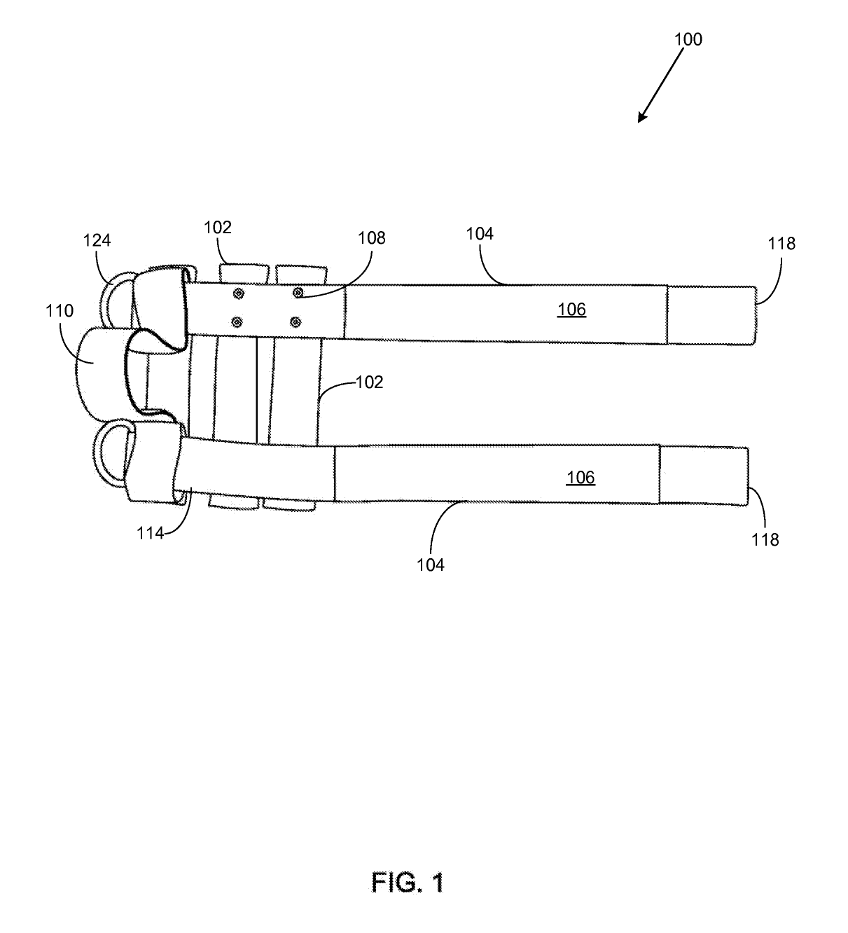

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1 to 5 illustrate a hose gripping apparatus 100 for enhancing an applied grip on a pressurized hose 200. In some embodiments, the hose gripping apparatus 100 may be effective for enhancing an operator's grip on pressurized hose 200 through the strategic placement of at least one pressure pad 102 on the outer surface of the hose. Pressure pad 102 contours to the shape of hose 200 and is fabricated from resilient, yet rigid rubber materials that are efficacious for magnifying an applied grip pressure on hose 200 during operation.

Apparatus 100 further utilizes an oversized and visible handle 110 helps orient the pressurized hose during operation. A plurality of adjustable fasteners, such as hook and loop fasteners also enable variously sized and pressurized hoses 200 to be used. These components of apparatus may be efficacious for enhancing operation of a pressurized hose 200 during moments of rigorous activity.

In one embodiment, apparatus 100 provides a simple, reliable and predictable interface between a human firefighter's gloved hand 202 and a high pressure, heavy caliber hose 200. The relatively ergonomically designed apparatus 100 may be effective for magnifying hand grip pressure, minimizing muscle fatigue, and allowing efficient positioning and operation of pressurized hose 200. In further embodiments, apparatus 100 may also serve as an emergency hose dressing or bandage for controlling a sudden rupture point on pressurized hose 200.

FIG. 1 illustrates an outer surface view of apparatus 100. Apparatus 100 includes an outer surface 106 that forms the contact point for the operator to grip and apply a grip pressure. Outer surface 106 forms a generally slip resistant surface that facilitates manipulation of pressurized hose 200, while engaged within apparatus 100.

In some embodiments, apparatus 100 include at least one pressure pad 102. It is the pressure pad 102, through a unique and layered configuration that magnifies the force applied on the pressurized hose, and thereby enhances control thereof. The pressure pad comprises a generally concave shape and a rigid composition. The concave surface area of pressure pad 102 conforms efficiently to the surface of pressurized hose.

When wrapped around pressurized hose 200, the at least one pressure pad provides the structure and shape to magnify the grip from an operator and inhibit slippage with pressurized hose. Pressure pad is fabricated from multiple layers of different materials. In one embodiment, pressure pad 102 may include an inner rigid member 120 and a slip resistant coating 122, such as rubber.

In one embodiment, pressure pad 102 includes three parallel, spaced-apart pressure pads oriented parallel to each other. The three pressure pads at least partially wrap around pressurized hose 200, aligning along a longitudinal axis of pressurized hose 200. In this manner, a pair of hands holding the apparatus 100 applies pressure directly onto pressure pad 102, which consequently magnify and transfer the applied pressure to pressurized hose 200. Suitable materials for pressure pad 102 may include, without limitation, rubber, polyurethane, and a rigid polymer.

Apparatus 100 further includes a pair of straps 104. Pair of straps 104 are defined by a first end 114, a second end 118, an outer surface 106, and an inner surface 116. Straps 104 are disposed to transversely engage pressure pad 102. Straps 104 are arranged to cross over the outer end of each pressure pad 102, fastening thereto. In one exemplary disposition, three pressure pads extend perpendicularly across straps 104, proximally to first end 114 of straps 104.

At least one pad fastener 108 may pass through the junction where straps 104 intersect at pressure pad 102, for securing pressure pad 102 to pair of straps 104. At least one pad fastener 108 may include, without limitation, rivets, T-nuts, screws, bolts, washers, buttons, and magnets. In another embodiment, pad fastener 108 includes twelve blind rivets and matching washers that pass through where straps 104 intersect with pressure pad 102. In this manner, straps 104 and pressure pad 102 form a single unit for wrapping around pressurized hose 200.

Straps 104 may include a webbing material having sufficient length to wrap around pressurized hose 200. In one embodiment, straps 104 include a 21″ webbing material. Those skilled in the art will recognize that apparatus 100 is used for firefighting. Consequently, straps 104 comprise a substantially heat resistant material. Straps 104 are adjustable to conform to different diameters and pressures of pressurized hose 200. Straps 104 also comprise sufficient strength to wrap around pressurized hose 200. In some embodiments, straps 104 include an abrasion and heat resistant outer surface 106.

The strap outer surface 106 includes a handle 110. Handle 110 may extend from a terminal end of straps 104, connecting each strap together over a pressure pad 102. At least one handle fastener (not shown), such as a blind rivet, secures each end of handle 110 to the respective strap end. Handle 110 is visible for facilitating orientation of pressurized hose 200 during operation. Handle 110 is also sufficiently large to provide a large surface for gripping and controlling pressurized hose 200. In one embodiment, handle 110 includes a U-shaped webbing material having a length of about 16″. The handle also comprises a heat shield and a substantially heat resistant material composition like the pair of straps.

The pair of straps are configured to adjustably fasten around pressurized hose 200 through a ring 124 and/or a hook and loop fastening material. In one embodiment, ring 124 is disposed to join with first end 114 of straps 104. Ring 124 is configured to enable second end 118 of each strap 104 to detachably attach to its corresponding first end 114, such that apparatus 100 securely fastens around pressurized hose 200.

For example, second end 118 may wrap around hose 200 and then tie around ring 124 on first end 114 in any number of tying or fastening techniques known in the art. Ring 124 enables fast and efficient detachable attachment between apparatus 100 and pressurized hose 200. In one possible embodiment, the ring is a metal loop-shaped member that passes through a slot at the terminus of first end 114.

The pair of straps may also utilize hook and loop fasteners to detachably join at their ends 114, 118. For example, in one exemplary embodiment, outer surface 106 of straps 104 may include an outer fastening material, such as a hook and loop fastener. In one embodiment, the outer fastening material includes two sections of 8″×2″ hook and loop fastening material. The outer fastening material may extend along one end of each strap 104, such that when straps 104 are wrapped around pressurized hose 200, the outer fastening material is exposed and ready for mating with another fastening material.

In this manner, each fastening material may be unfastened to tighten or loosen straps 104 around pressurized hose 200, and then refastened to achieve a desired diameter. It is significant to note that a tight fit for the straps 104 around pressurized hose 200 provides optimal grip. Also during firefighting fast readjustments, as provided by hook and loop fasteners, may be necessary to adjust for pressure variations in pressurized hose 200.

In one embodiment, apparatus 100 compacts into a small, portable unit for facilitated stowage and transport. For example, straps 104 may be rolled around pressure pad 102 and fastened at their ends through ring 124 or with the inner and outer fastening material. In this manner, apparatus 100 may be quickly accessed for emergency firefighting. From this compact position, handle 110 may be used to carry apparatus 100.

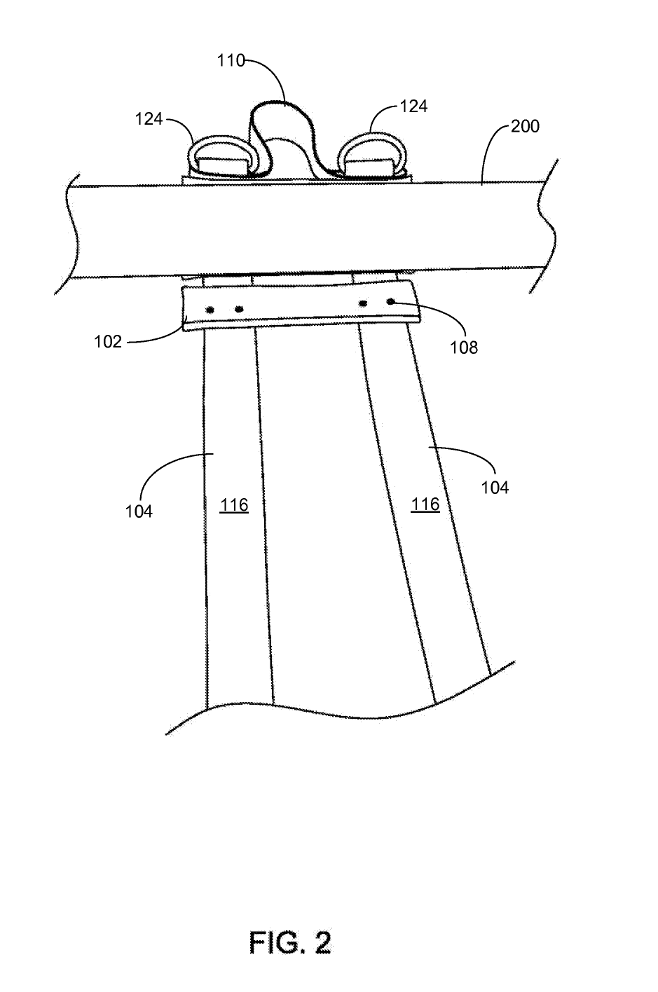

FIG. 2 illustrates strap inner surface 116. Inner surface 116 may include an inner fastening material on an opposite end of straps 104 from the outer fastening material. In this manner, straps 104 are operable to wrap around pressurized hose 200 and fasten the inner and outer fastening materials together. In one embodiment, the inner fastening material includes two sections of 8″×2″ hook and loop fastening material. Though in other embodiments, fasteners such as magnets, buttons, and screws may be used.

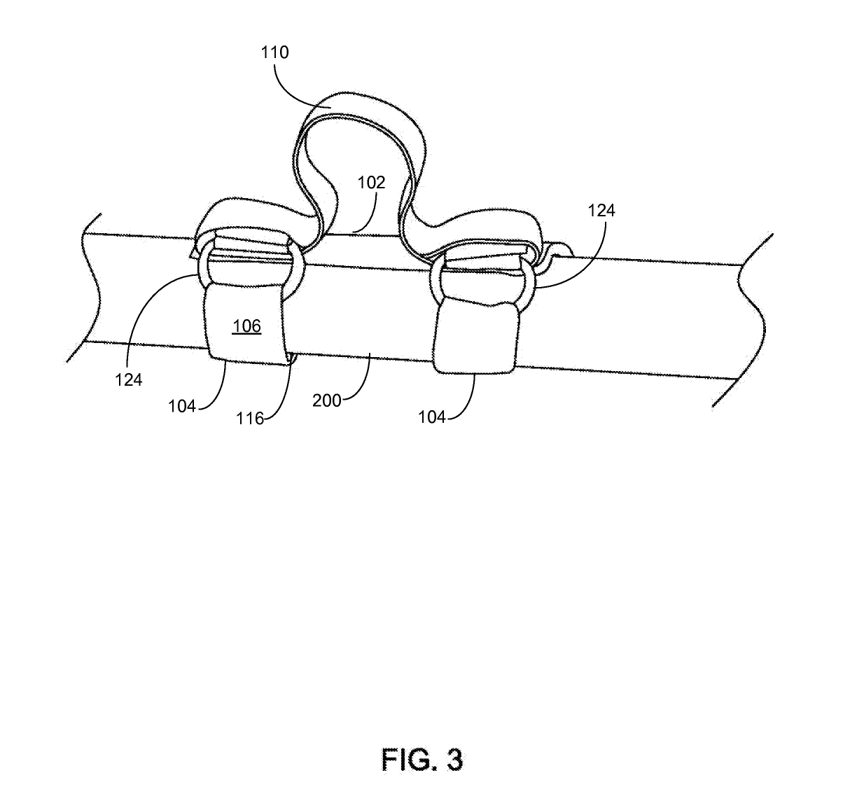

FIG. 3 illustrates apparatus 100 fully wrapped around pressurized hose 200. Those skilled in the art will recognize that, when operating at typical water pressures of 50-100 lbs, firehoses are extremely hard to handle. They are heavy, stiff, slippery and difficult to grip. Thus, the apparatus is configured to facilitate control and magnify the force applied to the apparatus during operation of hose 200.

For example, in one embodiment, handle 110 is oriented towards the operator for facilitated gripping. Straps 104 are tightly fit around pressurized hose 200. Pressure pad 102 is engaged with pressurized hose 200, sandwiched between straps 104 and hose 200. In operation, pressurized hose 200 is placed along a middle pressure pad and the pair of straps are wrapped around the pressurized hose until a desired tightness is achieved.

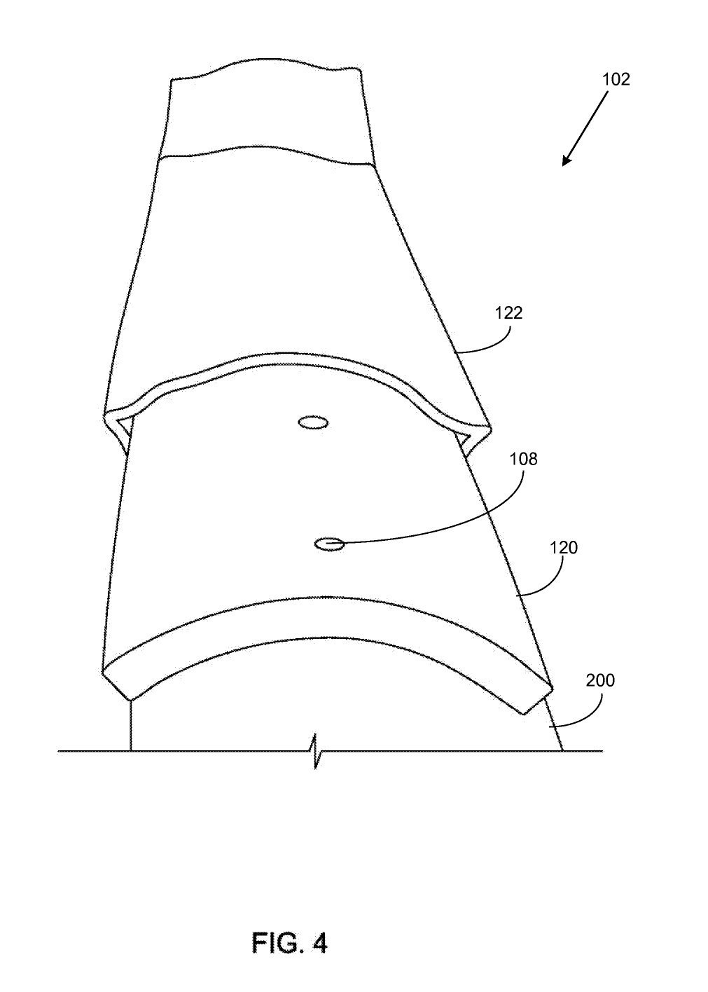

FIG. 4 illustrates a close up view of pressure pad 102 with an outer slip resistant coating 122 partially removed for illustration of an inner rigid member 120. Slip resistant coating 122 may include any composition or material efficacious for inhibiting slippage by a hand, especially a gloved hand 202. However, once slip resistant coating 122 is removed, inner rigid material 120 is visible. Inner rigid material 120 makes up the base of pressure pad 102. Inner rigid material 120 is sufficiently flexible to transfer the applied pressure from gloved hand 202 of the operator to pressurized hose 200. In one embodiment, the inner rigid material is drilled and covered with a heat resistant webbing material.

In some embodiments, apparatus 100 may not only be used to enhance grip during operation of pressurized hose 200, but also serve as a dressing or bandage to temporarily close a ruptured hose (not shown). In operation of sealing the ruptured hose, pressurized hose 200 may be placed on a middle pressure pad, such as shown in FIG. 2. An improvised bulky dressing (not shown), such as a spare work glove or rag is placed on top of the hose. In a loose manner, the dressing is wedged between pressure pad 102 and point of rupture on pressurized hose 200.

At this point, straps 104 may then be loosely wrapped around pressurized hose 200 in anticipation of movement along a longitudinal axis of the hose to the rupture point. The entire apparatus 100 and dressing may then slide over the rupture point and straps 104 can be tightened and fastened as desired. However, those skilled in the art will recognize that the mended hose should be monitored accordingly.

In one alternative embodiment, pair of straps 104 can be elastic and include additional hardware such as buckling material or snaps rather than the hook and loop fasteners. The pair of straps may also be configured to incorporate “d” rings and the like, to allow for a tighter wrap around the pressurized hose. In yet another alternative embodiment, apparatus 100 may be constructed without slip resistant coating 122 on pressure pad 102, whereby inner rigid material 120 is exposed.

In yet another alternative embodiment, apparatus 100 can be fabricated with any number of individual pressure pads or without any pressure pads. Additionally, Straps 104 can be wrapped around pressurized hose 200 alone or with a friction enhancing slip resistant coating 122.

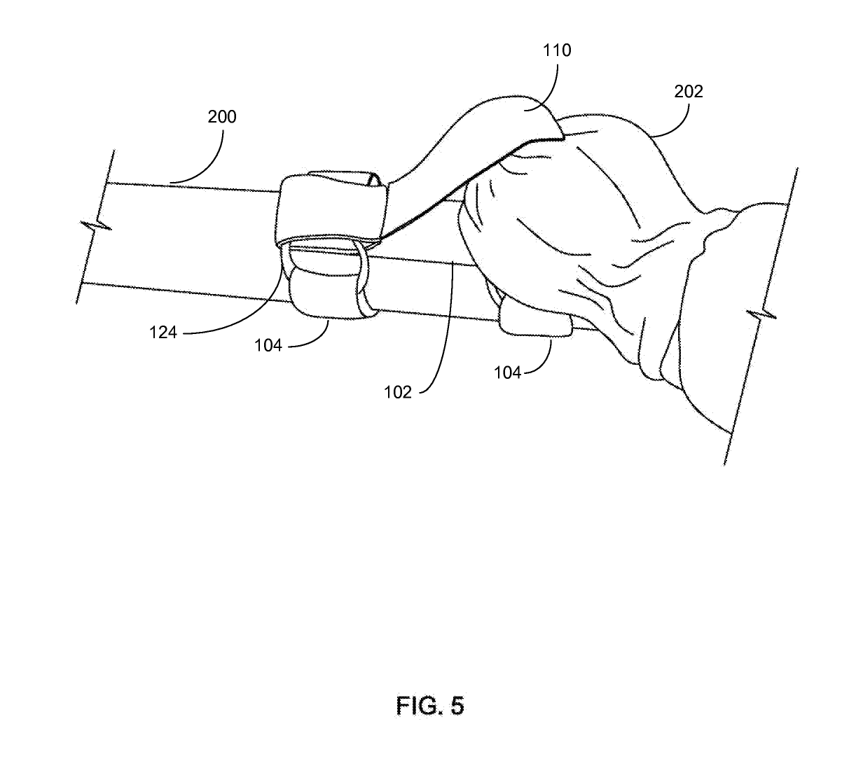

FIG. 5 illustrates a gloved hand 202 gripping handle 110 of apparatus 100. Handle 110 provides a secure gripping surface for pressurized hose 200 as liquid discharges at a high pressure therefrom. In essence, apparatus 100 forms a large grip surface area and an effective traction surface over pressurized hose 200. Apparatus 100 also creates an ergonomic grip strength for the applied pressure of gloved hand 202 of the operator. Additionally, apparatus 100 allows the operator to apply hand grip pressure rather than relying on tools, such as clamps and springs. These features and others combine to offer confident control of pressurized hose 200, while minimizing muscle fatigue during use of pressurized hose 200.

In essence, apparatus 100 provides a simple, reliable and predictable interface between a human firefighter's gloved hand and a high pressure, heavy caliber fire hose. Apparatus 100 can be easily folded and stored in a firefighters pocket and easily deployed and adjusted with gloved hand 202. In addition to apparatus' 100 use for gripping and advancing a fire hose, apparatus 100 can also act as an emergency hose bandage in the event of a sudden breach in a hose jacket.

These and other advantages of the invention will be further understood and appreciated by those skilled in the art by reference to the following written specification, claims and appended drawings.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A hose gripping apparatus for enhancing a grip on a pressurized hose, the hose gripping apparatus comprising:
at least one pressure pad defined by a generally concave shape, the at least one pressure pad comprising an inner rigid member configured to provide structural integrity, the at least one pressure pad further comprising a slip resistant coating configured to inhibit slippage,
wherein the generally concave shape of the at least one pressure pad is configured to magnify an applied force;
a pair of straps defined by a first end, a second end, an outer surface, and an inner surface, the pair of straps configured to join with the at least one pressure pad in a substantially perpendicular orientation;
a ring, the ring disposed to join with the first end of the pair of straps, the ring configured to enable the second end of the pair of straps to detachably attach to the first end of the pair of straps; and
a handle defined by a pair of handle ends, the pair of handle ends disposed to join with opposite ends of the at least one pressure pad, the handle configured to form a gripping surface for controlling the apparatus.

2. The apparatus of claim 1, wherein the apparatus is configured to detachably attach to a pressurized hose.

3. The apparatus of claim 1, wherein the at least one pressure pad comprises a rubber material.

4. The apparatus of claim 1, wherein the at least one pressure pad includes three parallel, evenly-spaced pressure pads.

5. The apparatus of claim 1, wherein the at least one pressure pad comprises a slip resistant coating configured to engage the pressurized hose, the slip resistant coating further configured to inhibit slippage between the pressurized hose and the apparatus.

6. The apparatus of claim 1, wherein the at least one pad fastener is a blind rivet and a washers.

7. The apparatus of claim 1, wherein the pair of straps comprise at least one pad fastener configured to fasten the pair of straps to the at least one pressure pad.

8. The apparatus of claim 1, wherein the pair of straps is fabricated from a heat resistant material.

9. The apparatus of claim 1, wherein the outer surface fastening material and the inner surface fastening material are a hook and loop fastener.

10. The apparatus of claim 1, wherein the outer surface fastening material is configured to detachably fasten to the inner surface fastening material.

11. The apparatus of claim 1, wherein the ring is configured to pass through a slot at the terminus of the first end of the pair of straps.

12. The apparatus of claim 1, wherein the ring is a stainless steel loop.

13. The apparatus of claim 1, wherein the handle is fabricated from a heat resistant material.

14. The apparatus of claim 1, wherein the handle comprising at least one handle fastener configured to fasten the pair of handle ends to the opposite ends of the at least one pressure pad

15. The apparatus of claim 1, wherein the handle is a resilient, heat resistant nylon material.

16. A hose gripping apparatus for enhancing a grip on a pressurized hose, the hose gripping apparatus comprising:
at least one pressure pad defined by a generally concave shape, the at least one pressure pad comprising an inner rigid member configured to provide structural integrity, the at least one pressure pad further comprising a slip resistant coating configured to inhibit slippage,
wherein the generally concave shape of the at least one pressure pad is configured to magnify an applied force;
a pair of straps defined by a first end, a second end, an outer surface, and an inner surface, the pair of straps configured to join with the at least one pressure pad in a substantially perpendicular orientation,
the outer surface of the pair of straps comprising an outer surface fastening material disposed at the first end of the pair of straps,
the inner surface of the pair of straps comprising an inner surface fastening material disposed at the second end of the pair of straps,
wherein the outer surface fastening material is configured to fasten with the inner surface fastening material to enable the second end of the pair of straps to detachably attach to the first end of the pair of straps; and
a handle defined by a pair of handle ends, the pair of handle ends disposed to join with opposite ends of the at least one pressure pad, the handle configured to form a gripping surface for controlling the apparatus.

17. A hose gripping apparatus for enhancing a grip on a pressurized hose, the hose gripping apparatus comprising:
at least one pressure pad defined by a generally concave shape, the at least one pressure pad comprising an inner rigid member configured to provide structural integrity, the at least one pressure pad further comprising a slip resistant coating configured to inhibit slippage,
wherein the generally concave shape of the at least one pressure pad is configured to magnify an applied force;
a pair of straps defined by a first end, a second end, an outer surface, and an inner surface, the pair of straps configured to join with the at least one pressure pad in a substantially perpendicular orientation,
the outer surface of the pair of straps comprising an outer surface fastening material disposed at the first end of the pair of straps,
the inner surface of the pair of straps comprising an inner surface fastening material disposed at the second end of the pair of straps,
wherein the outer surface fastening material is configured to fasten with the inner surface fastening material to enable the second end of the pair of straps to detachably attach to the first end of the pair of straps;
a ring, the ring disposed to join with the first end of the pair of straps, the ring configured to enable the second end of the pair of straps to detachably attach to the first end of the pair of straps; and
a handle defined by a pair of handle ends, the pair of handle ends disposed to join with opposite ends of the at least one pressure pad, the handle configured to form a gripping surface for controlling the apparatus.

18. The apparatus of claim 17, wherein the at least one pressure pad comprises a slip resistant coating configured to engage the pressurized hose, the slip resistant coating further configured to inhibit slippage between the pressurized hose and the apparatus.

19. The apparatus of claim 17, wherein the outer surface fastening material and the inner surface fastening material are a hook and loop fastener.

20. The apparatus of claim 17, wherein the ring is a stainless steel loop.
